(19) United States
(12) Patent Application Publication
(10) Pub. No.: US 2021/0295787 A1
(43) Pub. Date: Sep. 23, 2021

(54) DISPLAY DEVICE

(71) Applicant: AU Optronics Corporation, Hsin-Chu (TW)

(72) Inventors: Sin-Jie WANG, HSIN-CHU (TW); Kuo-Hsiang CHEN, HSIN-CHU (TW); Hsiang-Chi CHENG, HSIN-CHU (TW); Ya-Ting LIN, HSIN-CHU (TW); Shyh-Bin KUO, HSIN-CHU (TW); Yi-Cheng LAI, HSIN-CHU (TW); Yu-Chih WANG, HSIN-CHU (TW); Chung-Hung CHEN, HSIN-CHU (TW)

(21) Appl. No.: 17/115,830

(22) Filed: Dec. 9, 2020

(30) Foreign Application Priority Data
Mar. 23, 2020 (TW) 109109652

(51) Int. Cl. G09G 3/34

(52) U.S. Cl. CPC G09G 3/3406; G09G 2310/08; G09G 2320/064; G09G 2360/141; G09G 2360/144

(57) ABSTRACT

The present disclosure relates to a display device including a backlight circuit, a processing circuit, and a clock generation circuit. The backlight circuit is configured to be driven in response to a control signal. The processing circuit is electrically connected to the backlight circuit and is configured to generate a voltage signal and the control signal. The clock generating circuit is electrically connected to the processing circuit to receive the voltage signal. The processing circuit is configured to adjust the control signal according to a clock frequency of the clock signal.

### CROSS-REFERENCE TO RELATED APPLICATION

This application claims priority to Taiwan Application Serial Number 109109652, filed Mar. 23, 2020, which is herein incorporated by reference in its entirety.

### BACKGROUND

### Technical Field

The present disclosure relates to a display device, especially a device capable of adjusting the brightness of a display panel by a backlight circuit.

### Description of Related Art

Currently, various mobile electronic devices are usually equipped with a light source sensor for detecting the ambient light sources around the mobile electronic device. The mobile electronic device executes corresponding operations or adjusts display parameters according to the brightness of the ambient light source. The position or manufacturing process of the light source sensor will affect the configuration of other components (e.g., the display panel) in the mobile electronic device, which has become a major issue in product design.

### SUMMARY

One aspect of the present disclosure is a display device, comprising a backlight circuit, a processing circuit and a clock generation circuit. The backlight circuit is configured to be driven in response to a control signal. The processing circuit is electrically connected to the backlight circuit, and is configured to generate a voltage signal and the control signal. The clock generation circuit is electrically connected to the processing circuit to receive the voltage signal. The clock generation circuit is configured to transmit a clock signal to the processing circuit according to the voltage signal and an ambient light, and the processing circuit is configured to adjust the control signal according to a clock frequency of the clock signal.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a display device in some embodiments of the present disclosure.

FIG. 2 is a schematic diagram of a display device in some embodiments of the present disclosure.

FIG. 3 is a schematic diagram of a clock generation circuit in some embodiments of the present disclosure.

FIG. 4 is a schematic diagram of a correction method of the clock generation circuit in some embodiments of the present disclosure.

FIG. 5A is a schematic diagram of a clock generation circuit in some embodiments of the present disclosure.

FIG. 5B is a waveform of a clock signal of the clock generation circuit in some embodiments of the present disclosure.

FIG. 6A is a schematic diagram of a clock generation circuit in some embodiments of the present disclosure.

FIG. 6B is a waveform of a clock signal of the clock generation circuit in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes an associated listed items or any and all combinations of more.

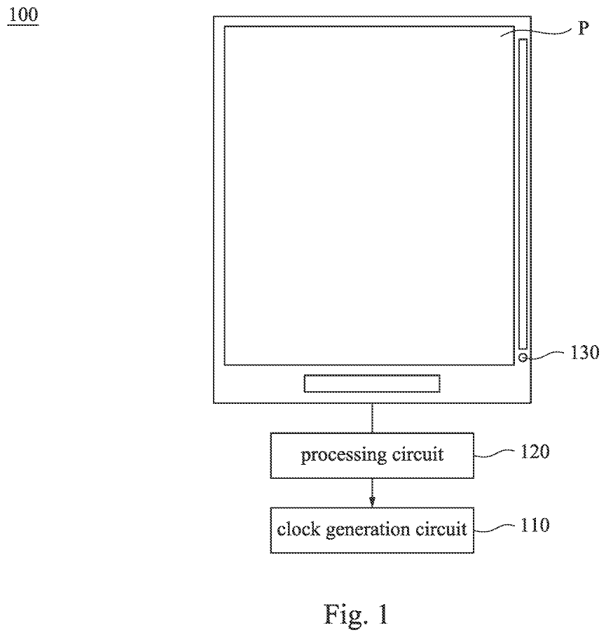

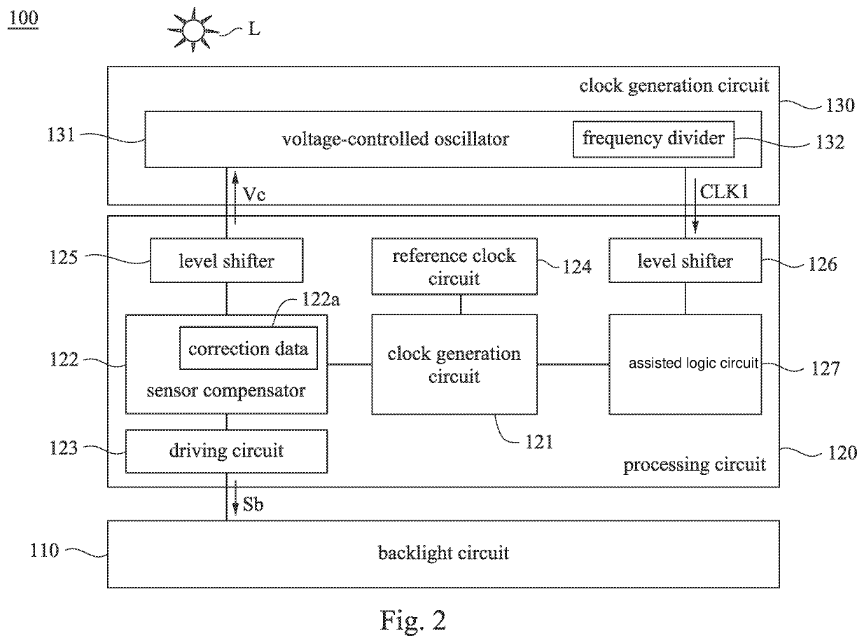

The present disclosure relates to a display device. FIG. 1 and FIG. 2 are schematic diagrams of a display device 100 in some embodiments of the present disclosure. The display device 100 includes a backlight circuit 110, a processing circuit 120, a clock generation circuit 130 and a display panel P. In some embodiments, the display panel P and the clock generation circuit 130 are arranged on the same side of the display device 100. The backlight circuit 110 and the processing circuit 120 set inside the display device 100.

The position of the backlight circuit 110 corresponds to the pixel circuit (not shown in the figure) of the display panel P, and includes multiple light emitting elements (e.g., LED). The backlight circuit 110 is configured to receive a control signal Sb transmitted by the processing circuit 120, and is driven in response to the control signal Sb to project light in the direction of the pixel circuit.

The processing circuit 120 is electrically connected to the backlight circuit 110, the display panel P and the clock generation circuit 130, and is configured to generate a voltage signal Vc and the control signal Sb. The processing circuit 120 is configured to perform various calculations. In some embodiments, the processing circuit 120 may be implemented by a microcontroller, a microprocessor, a digital signal processor, an application specific integrated circuit (ASIC) or a logic circuit.

The clock generation circuit 130 is configured to receive the voltage signal Vc, and outputs the clock signal CLK1 according to the voltage signal Vc and the magnitude of the ambient light L. In this embodiment, the clock generation circuit 130 includes a light-dependent electronic component, so that the electrical characteristics of the clock generation circuit 130 changes according to the magnitude of the ambient light L, and the clock frequency of the clock signal CLK1 corresponds to the magnitude of the ambient light L. Alternatively stated, the clock generation circuit 130 is used to a part of the light source sensor in the display device 100.

The above the ambient light means the environment brightness around the display device 100. For example, when the display device 100 is in an outdoor daytime environment, the brightness of the ambient light L is higher. On the other hand, if the display device 100 is in a night and no lighting environment, the brightness of the ambient light L is lower.

The clock generation circuit 130 is configured to transmit the clock signal CLK1 to the processing circuit 120. The clock frequency of the lock signal CLK1 corresponds to the magnitude of the ambient light L. Therefore, the processing circuit 120 adjusts the control signal Sb according to the clock frequency of the clock signal CLK1. For example, when the clock frequency increases, it means that the brightness of the ambient light L is higher. At this time, the processing circuit 120 may increase the magnitude of the voltage of the control signal Sb to increase the brightness of the backlight circuit 110.

Referring to FIG. 1, the clock generation circuit 130 is arranged on the display device 100 adjacent to a display panel P. A light-dependent electronic component of the clock generation circuit 130 is exposed on the surface of the display device 100 to be able to detect the magnitude of the ambient light L. The present disclosure uses “clock” to detect “the ambient light”, so that the clock generation circuit 130 can be used as a digital light source sensor. Due to the small size of the clock generation circuit 130, the clock generation circuit 130 can be arranged next to the display panel P without limiting the area of the display panel P.

In addition, in one embodiment, the clock generation circuit 130 can be fabricated in the manufacturing process of the display panel P. The clock generation circuit 130 is formed on the process substrate of the thin-film transistor (TFT) on the display panel P as a thin-film transistor photosensitive circuit (light source sensor) of the display device. Alternatively stated, the clock generation circuit 130 as a light source sensor does not affect the production efficiency and cost of the display device 100.

In some embodiments, the TFT process substrate is made of transistor amorphous silicon (a-Si), low temperature poly-silicon (LTPS) or indium-gallium-zinc-oxide (Indium-Gallium-Zinc-Oxide) and other technologies, which is dependent on light. In other embodiments, the manufacturing process of the display panel P can refer to U.S. Pat. No. 7,682,883, but the present disclosure is not limited to this.

As mentioned above, the clock generation circuit 130 has light dependence, and when the ambient light L changes, the electrical characteristics of the clock generation circuit 130 changes accordingly. Electrical characteristics can be the impedance of an electronic component or the threshold voltage of the transistor switch. In some embodiments, the clock generation circuit 130 includes at least one transistor switch, and the threshold voltage of the transistor switch changes according to the ambient light L. The processing circuit 120 provides a fixed magnitude of the voltage signal Vc to the clock generation circuit. When the ambient light L does not change, the clock frequency of the clock signal CLK output by the clock generation circuit 13 will remain fixed. Therefore, once the clock frequency of the clock signal CLK changes, the processing circuit 120 can determine that the ambient light L has changed. For example, when the threshold voltage of the transistor switch decreases according to the change of the ambient light L, the clock frequency of the clock signal CLK1 generated by the clock generation circuit 130 will increase.

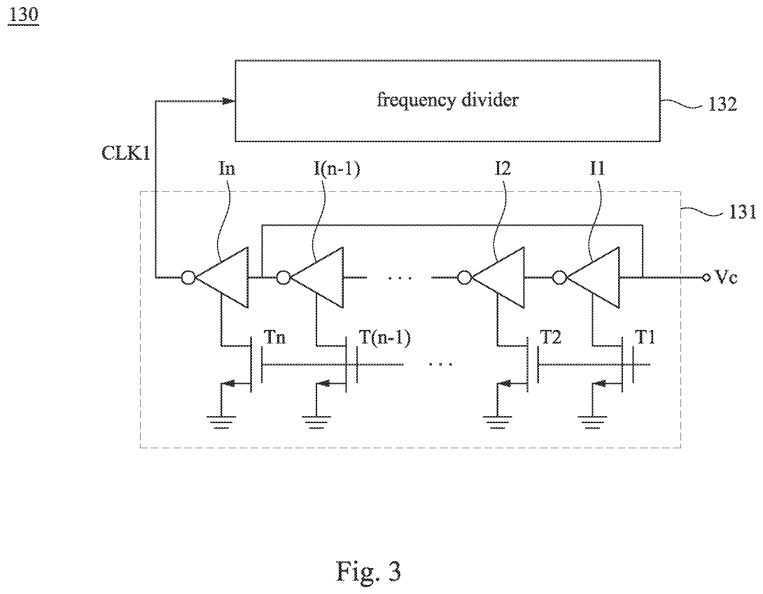

Referring to FIG. 3, FIG. 3 is a schematic diagram of a clock generation circuit in some embodiments of the present disclosure. In some embodiments, the clock generation circuit 130 includes a voltage-controlled oscillator 131. The voltage signal Vc transmitted by the processing circuit 120 to the clock generation circuit 130 is a power supply voltage. The voltage-controlled oscillator 131 changes the clock frequency of the output clock signal CLK according to the power supply voltage. The voltage-controlled oscillator 131 of the clock generation circuit 130 includes multiple inverters I1-In and multiple switching elements T1-Tn. The inverters I1-In are connected in series with each other, and the switching elements T1-Tn are electrically connected to multiple control terminals of the inverters I1-In.

The circuit shown in FIG. 3, the voltage-controlled oscillator 131 can be a ring oscillator. The negative power supply terminals of the inverters I1-In are connected to the ground terminals through the switching elements T1-Tn. In some embodiments, each of the switching elements T1-Tn includes a transistor switch (e.g., thin film transistor), and the inverters I1-In include multiple the transistor switches. The transistor switch may be an N-type TFT or a P-type TFT. According to the circuit shown in FIG. 3, the relationship between frequency and time of the clock generation circuit 130 is represented by the following characteristic formula:

$$F = \frac{1}{( {t}_{PLH} + {t}_{PHL} ) \times N}$$

$${t}_{PHL} = \frac{( {C}_{G} + {C}_{p} ) ( {V}_{OH} / 2 )}{( 1 / 2 ) {u}_{N} {{C}_{ox} ( W / L )}_{n} {( {V}_{OH} - {V}_{rn} )}^{2}}$$

$${t}_{PLH} = \frac{( {C}_{G} + {C}_{p} ) ( {V}_{OH} / 2 )}{( 1 / 2 ) {μ}_{n} {{C}_{ox} ( W / L )}_{p} {( {V}_{OH} - {V}_{rp} )}^{2}}$$

In the above characteristic formula, t_{PHL} is defined as a delay time when the clock generation circuit 130 controls the clock signal CLK1 to change from the high potential to the low potential. Alternatively stated, the clock generation circuit 130 is configured to determine the delay time between the clock signal CLK1 changing from the high potential to the low potential. t_{PLH} is defined as a delay time when the clock generation circuit 130 controls the clock signal CLK1 to change from the low potential to the high potential. Alternatively stated, the clock generation circuit 130 is configured to determine the delay time between the clock signal CLK1 changing from the low potential to the high potential. F is the frequency of the clock signal CLK1. V_{Tn} and V_{Tp} are the threshold voltage of N-type TFT and P-type TFT respectively (in this embodiment, the inverter includes N-type TFT or P-type TFT). According to the above characteristic formula, when the threshold voltage of N-type TFT and P-type TFT decreases due to the increase of the ambient light, t_{PHL} and t_{PLH} will decrease, and the clock frequency F will increase.

In addition, in this embodiment, the voltage-controlled oscillator 131 of the clock generation circuit 130 includes a frequency divider 132. The frequency divider 132 is configured to decrease the number of samples of the clock signal CLK1 sampled by the voltage-controlled oscillator 131 to reduce the burden of the processing circuit 120. The frequency divider 132 transmits the processed clock signal CLK1 to the processing circuit 120.

Referring to FIG. 2, in some embodiments, the processing circuit 120 includes a time-to-digital converter 121, a sensor compensator 122, the driving circuit 123, a reference clock circuit 124, a level shifter 125, 126 and an assisted logic circuit 127 (time-to-digital converter assisted logic circuit). The time-to-digital converter 121 generates the control signal Sb by the driving circuit 123, and generates the voltage signal Vc by the sensor compensator 122 and the reference clock circuit 124.

The level shifter 125 is configured to adjust the voltage level of Vc to be consistent with the operating voltage in the clock generation circuit 130. The level shifter 126 is configured to adjust the voltage level of the clock signal CLK1 to be consistent with the operating voltage in the processing circuit 120, and is configured to transmit the processed clock signal CLK1 back to the time-to-digital converter 121 through the assisted logic circuit 127.

In some embodiments, the sensor compensator 122 further stores a correction data 122a. The correction data 122a includes a frequency setting value. For example, when the pulse peak of the voltage signal Vc is 5V, the expected frequency (i.e., the frequency setting value) generated by the clock generation circuit 130 should be 3 MHz. The processing circuit 120 is configured to correct the clock generation circuit 130 according to the correction data 122a to avoid errors caused by a “structural difference” between the transistor switches inside the clock generation circuit 130. The above structural difference is the structural difference between the transistors produced in different batches.

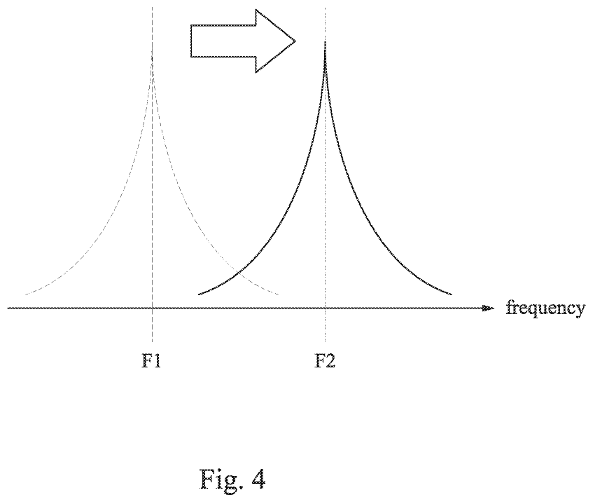

As shown in FIG. 4, since the characteristics of the transistor switch in the clock generation circuit 130 may be different, after the clock generation circuit 130 receives the voltage signal Vc, the clock frequency of the generated clock signal CLK has an error due to the structural difference between the transistor switches. For example, when the voltage signal Vc is 5V, the expected frequency (i.e., the frequency setting value) generated by the clock generation circuit 130 should be 3 MHz. In the case that the display device 100 does not receive the ambient light, the processing circuit 120 provides the voltage signal Vc of 5V to the clock generation circuit 130. Next, the processing circuit 120 receives the clock signal CLK1 returned by the clock generation circuit 130, and determines whether the clock frequency of the clock signal CLK1 is corresponding to (or is consistent with) the frequency setting value. If the clock frequency in the clock signal CLK1 does not correspond to the frequency setting value (as shown in FIG. 4, frequency F1 is 2.8 MHz, which is different from the frequency setting value of 3 MHz), it means that the clock generation circuit 130 should be corrected. At this time, the processing circuit 120 adjusts the voltage signal Vc (e.g., increase to 5.2V) so that the clock frequency of the clock signal CLK1 corresponds to the frequency setting value (as shown in FIG. 4, the adjusted frequency F2 is 3 MHz). The processing circuit 120 records the adjusted voltage signal Vc, and sets the adjusted voltage signal Vc “5.2V” as a new voltage signal Vc.

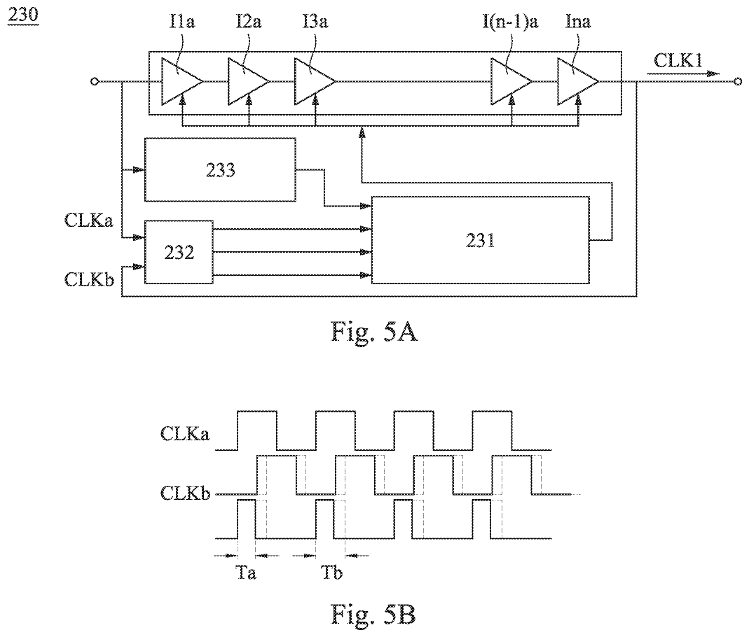

Referring to FIG. 5A and FIG. 5B, FIG. 5A is a schematic diagram of a clock generation circuit in some other embodiments of the present disclosure. In this embodiment, the clock generation circuit 230 includes multiple inverters I1a-Ina connected in series, an ADMCG controller 231 (all-digital multiphase clock generator), an assisted logic circuit 232 and a time-to-digital converter 233 to form a voltage-controlled oscillator.

As shown in FIG. 5B, the inverters I1a-Ina is configured to form a delay line. The clock generation circuit 230 is configured to receive the input clock signal CLKa, CLKb, and output the clock signal CLK1. When the ambient light L changes, the clock signal CLKa and CLKb will have different the delay time Ta, Tb (e.g., when the brightness of the ambient light L is higher, the delay time is Ta; when the brightness of the ambient light L is lower, the delay time is Tb).

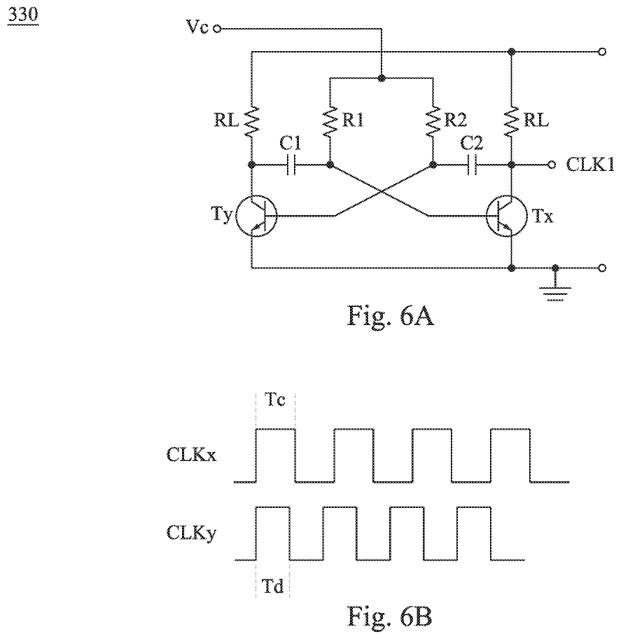

In some other embodiments, the clock generation circuit 330 may be implemented by the other types of the voltage-controlled oscillator. Referring to FIG. 6A, FIG. 6A is a schematic diagram of a clock generation circuit in some other embodiments of the present disclosure. The clock generation circuit 330 includes a cross couple circuit. The cross couple circuit includes multiple resistors R1, R2, multiple capacitors C1, C2 and two transistor switches Tx, Ty correspond to each other. In this embodiment, the transistor switch Tx is exposed to the display device 100 to sense the ambient light. Alternatively stated, the threshold voltage of the transistor switch Tx changes according to the ambient light. The transistor switch Ty is in the display device 100, and its threshold voltage remains fixed. Accordingly, the clock frequency of the clock signal CLK1 output by the clock generation circuit 330 will change according to the ambient light. The relationship between the impedance and the output clock frequency of the clock generation circuit 330 is represented by the following characteristic formula, wherein Req is the output equivalent impedance value of the clock generation circuit 330, and CL is the output load capacitor of the clock generation circuit 330:

$${R}_{eq} = \frac{1}{{μ}_{n} {{C}_{ox} ( W / L )}_{n} {( {V}_{GS} - {V}_{Tn} )}^{1}} ‖ RL \\ Frequency = \frac{1}{{R}_{eq} \times {C}_{L}}$$

Referring to FIG. 6B, FIG. 6B is a change waveform of the clock signal CLK1 output by the clock generation circuit 330. When the display device 100 is in a dark environment (i.e., not exposed to light), the period of the clock signal CLKX is Tc. When the display device is exposed to ambient light, the threshold voltage of the transistor switch Tx becomes low. At this time, the period Td of the clock signal CLKy output by the clock generation circuit 330 will be shorter. Alternatively stated, the frequency of the clock signal CLKy becomes higher.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A display device, comprising:
a backlight circuit configured to be driven in response to a control signal;
a processing circuit electrically connected to the backlight circuit and is configured to generate a voltage signal and the control signal; and
a clock generation circuit electrically connected to the processing circuit to receive the voltage signal, wherein the clock generation circuit is configured to transmit a clock signal to the processing circuit according to the voltage signal and an ambient light, and the processing circuit is configured to adjust the control signal according to a clock frequency of the clock signal.

2. The display device of claim 1, wherein the clock generation circuit comprises at least one transistor switch, and a threshold voltage of the at least one transistor switch changes according to the ambient light.

3. The display device of claim 2, wherein when the threshold voltage of the at least one transistor switch is decreases due to a change of the ambient light, the clock frequency of the clock signal generated by the clock generation circuit increases.

4. The display device of claim 1, wherein the clock generation circuit comprises a plurality of inverters connected in series.

5. The display device of claim 1, wherein the clock generation circuit comprises a voltage-controlled oscillator.

6. The display device of claim 5, wherein the voltage-controlled oscillator is a ring oscillator.

7. The display device of claim 5, wherein the clock generation circuit further comprises a frequency divider configured to reduce a number of samples of the clock signal of the voltage-controlled oscillator.

8. The display device of claim 5, wherein the voltage-controlled oscillator comprises a cross couple circuit, the cross couple circuit comprises two transistor switches corresponding to each other, and a threshold voltage of one of the two transistor switches changes according to the ambient light.

9. The display device of claim 1, wherein processing circuit comprises a correction data, the correction data comprises a frequency setting value, and the processing circuit is configured to correct the clock generation circuit according to the frequency setting value.

10. The display device of claim 9, wherein when the display device does not receive the ambient light, and the processing circuit determines that the clock frequency of the clock signal does not correspond to the frequency setting value, the processing circuit adjusts the voltage signal so that the clock frequency of the clock signal corresponds to the frequency setting value.
